(19) United States
(12) Patent Application Publication
(10) Pub. No.: US 2013/0204773 A1
(43) Pub. Date: Aug. 8, 2013

(54) RISK ASSESSMENT USING MAINTENANCE AFFORDABILITY INDICATOR

(71) Applicant: Steven Paul Wiese, Farmington, MI (US)

(72) Inventor: Steven Paul Wiese, Farmington, MI (US)

(21) Appl. No.: 13/747,252

(22) Filed: Jan. 22, 2013

Related U.S. Application Data
(60) Provisional application No. 61/588,339, filed on Jan. 19, 2012.

(51) Int. Cl. G06Q 40/02

(52) U.S. Cl. CPC G06Q 40/025
USPC 705/38

(57) ABSTRACT

A computer system implement a method of determining what loans in a portfolio contain borrowers/homeowners that will have difficulty maintaining their real estate. The method is based on a comparison of the market value to the reproduction cost of the real estate. This comparison provides insight into whether the borrower/homeowner has sufficient income to remedy any deficiency or deferred maintenance and maintain the property going forward at an acceptable level to provide adequate collateral for the lender.

### BACKGROUND OF THE INVENTION

The present invention relates generally to computer systems and more particularly a computer system for determining a value of a property and associating a risk assessment to a loan secured by the property.

The condition of the systems in most homes, even if they require replacement, repair or upgrade, often do not significantly impact the value or collateral interest a lender has in a home. However in some cases the systems in a home can significantly increase the bank's exposure to loss. Valuation products such as automated valuation models (AVM), drive by appraisals, desk reviews, and others that do not include an inspection have a significant short fall. They have no way of determining a condition of the property. This is less of a problem with new structures, however, as a structure ages, its condition is often the most important factor when comparing it to other similar structures. Unless a complete inspection is performed, lenders, insurance companies, or others concerned with the value of the property are unable to determine its condition. Further, even if a home is currently in good condition, there is a possibility that the homeowner may not maintain the home in a good condition throughout the potentially long life of the loan.

### SUMMARY OF THE INVENTION

The present invention provides a method and computer system for assessing risk related to a condition of a property.

Preferably, the computer system of the present invention includes a database for accessing information to determine a market value (specific value or range) for the property.

The condition of the systems in most homes, even if they require replacement, repair or upgrade, often do not significantly impact the value or collateral interest a lender has in a home. However in some cases the systems in a home can significantly increase the bank's exposure to loss. The extent of this can easily be determined with current and or readily available information. It is almost always the case that the higher the replacement cost of a home/structure in typical residential neighborhoods the greater the cost to replace, repair or upgrade its system and components. Examples of typical homes component systems are the roof, kitchen, baths, plumbing, electrical, heating and cooling, foundations and so on. These systems have a cost that is directly proportional to the replacement cost of the structure.

In the current housing market with values at their lowest point in years, more than ever, the difference between replacement cost and market value can vary greatly and the spread between these two numbers is greater than ever. Borrowers in the current market can afford and are able to purchase homes that they would have before never dreamed possible. These homes have greater gross living area, with higher quality amenities, resulting in additional cost burdens for upkeep.

A Maintenance Affordability Index (“MAI”) based upon a comparison of market value (or sales price, as a reflection of market value) and replacement cost provides an indication of the likelihood that the home will be well-maintained.

The greater the margin by which replacement cost exceeds market value, the greater the chance that a system component can greatly affect the lender's equity, as well as affecting the borrower's ability to maintain such a home. Even if the home is in average to good condition at the time of origination, further on down the road as the loan and the home age these systems will age and depreciate. Since most home buyers purchase homes relative to their income, within that purchase price it is usually the case that their income will provide for the insurance, taxes, maintenance and utilities for the real estate as well as other typical debts. However if replacement cost exceeds market value significantly (i.e. a high MAI), the ability for a home owner/borrower to provide for the costs of maintenance will be difficult and there is additional risk and hidden costs reflected by the MAI calculation.

Stagnant home prices compound the problem robbing the home owner of equity that could provide for maintenance and upkeep, as well as the desire to maintain what will turn out to be a money pit. A single large repair such as a roof can be a relatively large percentage of a home's value when the home has a risky MAI. In addition when system components are expensive in relation to Market Value this makes it difficult for even the most responsible home owners to maintain the home in good condition. Those borrowers who have purchased or own a home where this is not the case will be in a far better position to maintain the structure adequately. Real estate and banking professionals often see the results in today's market with home owners' inability to provide adequate home maintenance. Borrowers and home owners with risky MAI spreads are much more likely to have a home that if foreclosed on will require repair costs far exceeding homes with a smaller spreads eating up what value is left after foreclosure. Lenders by means of a computer system as well as networks such as the internet can calculate the MAI on mass to determine if a loan or loans meet acceptable risk tolerance for the lender in order for them to avoid having such homes in their portfolio or cut their losses early when such homes look like they will go into foreclosure.

While many homes are purchased under Market Value due to distressed sale circumstances, many are not. The most accurate measure for developing the MAI is Market Value however Sales Price is also useful. While Sales Price is often close or the same as Market Value it can sometimes be much lower in the current real estate market. Often these homes are in foreclosure and sell well under Market Value.

The MAI is still a useful calculation with sales price. Even if the home has additional equity from the purchase under market, the result will still be a larger spread. If the borrower cannot access this equity for whatever reason this too can result in as much or more risk than the market value calculation.

In addition most buyers who use low down payment loans in these circumstances such as FHA or VA most often purchase at Market Value. Buyers with short term interest like investors or flips most often use cash. The result is many risky loans are made to borrowers making low down payment loans in places where significant appreciation is unlikely.

### BRIEF DESCRIPTION OF THE DRAWINGS

The above, as well as other advantages of the present invention, will become readily apparent to those skilled in the art from the following detailed description of a preferred embodiment when considered in light of the accompanying drawings in which:

FIG. 1 is a schematic of a computer system according to one embodiment of the present invention;

FIG. 2 is a flow chart showing one method according to the present invention;

FIG. 3 is a table showing example calculations using one example of the present invention.

### DETAILED DESCRIPTION OF THE PREFERRED EMBODIMENT

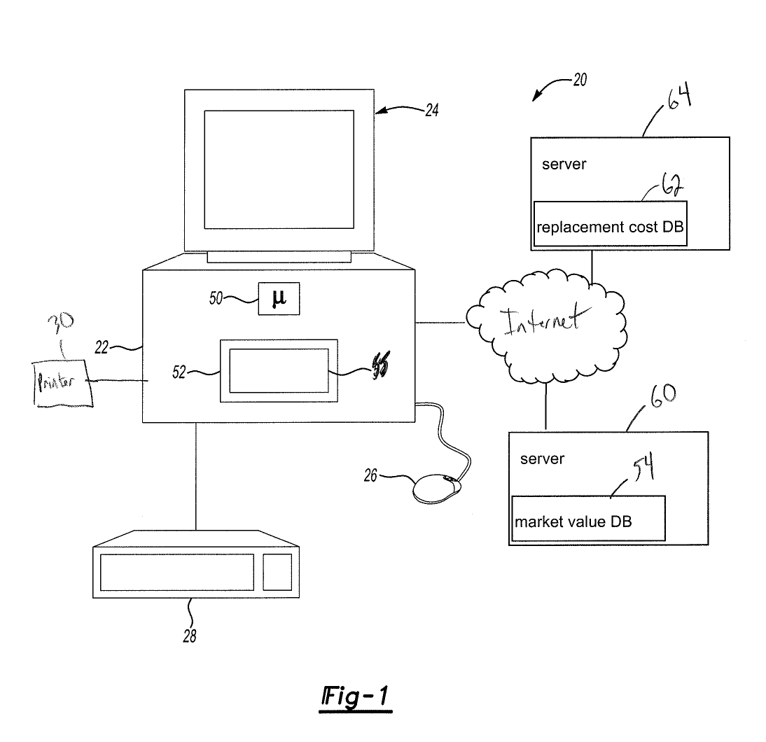

The present invention provides a computer system 20, as shown in FIG. 1, for determining a value of a property according to a method of the present invention. The computer system 20 includes a CPU 22 for creating a maintenance affordability indicator for the property and assigning a maintenance affordability index to the property in a manner which will be discussed below. The CPU 22 includes a display 24 and input devices, such as a mouse 26 and/or a keyboard 28. The CPU 22 is also connected to a printer 30. The CPU 22 includes a microprocessor 50 accessing computer memory 52, such as a hard drive, RAM, CD ROM, ROM, etc. The microprocessor 50 of the CPU 22 is preprogrammed with suitable software, stored in memory 52 (electronic memory or other computer storage media, such as hard drive, SSD, etc), to perform the functions described herein. The memory 52 may also store information relating to one or more loans in a database 55. The memory 52 could store a portfolio of loans (mortgages) that have already been made, or loans that are being considered.

A market value database 54 includes a current market value of a plurality of real properties. The market values may be produced by automated valuation models. The database 54 may be located on a separate computer, such as a server 60 accessible by the CPU 22 over a network, such as the Internet. A replacement cost database 62 stored on server 64 is accessible by the CPU 22 over the Internet. Alternatively, the market values and replacement costs could be stored locally in database 55 and/or entered by the user manually or generated on the fly. If current market value is not available, a recent sales price may be entered by the user (or may be accessible over the Internet).

The computer system 20 can compare and calculate the MAI of the loans in a large portfolio of mortgages to determine if a loan or loans in a portfolio meet acceptable risk tolerance for the lender. AVM (automated valuation models) applications are simple and the current technology is readily available. Lenders already use AVMs to screen loans for values and automated replacement or reproduction cost analysis is readily available from companies like Marshal and Swift often for insurance purposes. The greater the spread between Market Value and the Replacement Cost the greater the likelihood that the borrower will have difficulty maintaining the home. The spread can be calculated as a ratio of Replacement Cost to Market Value, or a dollar difference, or a percent difference, etc.

Standard appraisals provide both market value and cost approach. The cost approach could be calculated as replacement cost in order to complete this calculation. The same analysis is then done on the market value and replacement cost. The greater the spread between Market Value and Replacement Cost, the greater the likelihood that the borrower will have difficulty maintaining the home. This will be especially useful with new Uniform Appraisal Dataset UAD format from Fannie Mae & Freddie Mac allowing for simple analysis and screening using a computer system as well as networks such as the internet to compare and calculate the MAI on mass to determine if a loan or loans in their portfolio meet acceptable risk tolerance allowing them to act accordingly.

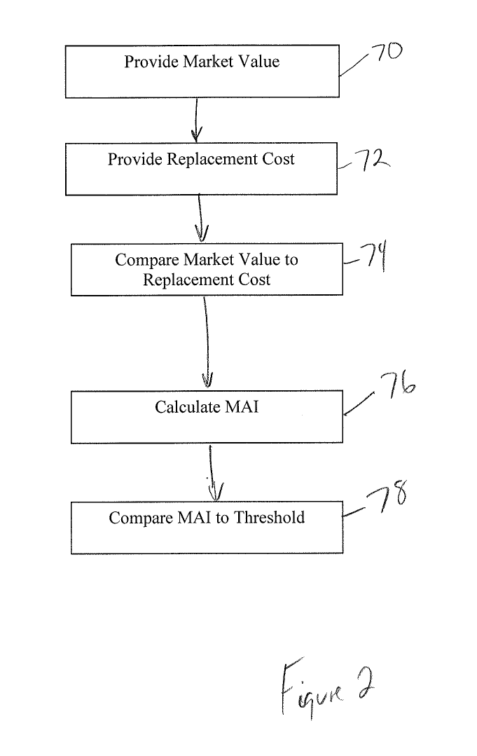

The method of the present invention is shown in FIG. 2. In step 70, the market value is provided, such as from market value database 54 (FIG. 1). In step 72, the replacement cost is provided, such as from replacement cost database 62 (FIG. 1). In step 74, the market value is compared to the replacement cost, such as by calculating a ratio, difference, or some more complicated mathematical comparison. In step 76, the Maintenance Affordability Indicator is calculated based upon the comparison in step 74. In step 78, the MAI is compared to a threshold to determine the level of risk indicated by the MAI. Preferably, steps 70-78 are performed by the CPU 22, although the multiple steps could also be broken among the several computers 22, 60, 64. For a portfolio of mortgages, steps 70-78 are repeated for each mortgage to determine the level of risk for each mortgage.

In the current housing market many in the real estate business see opportunities to buy high quality housing stock at extremely low prices. The market value of such homes and those purchasers who meet the required income to buy them make it possible for buyers to get the most for their money. In some cases lending on these homes is not a good risk. Neighborhoods in some areas have housing stock of very high quality with extremely low prices. The reasons for this vary, condition, poor schools, limited or low functioning city services like police and fire. In addition these areas often have limited or poor amenities such as parks or shopping. These factors all likely contribute to the low price of what are relatively good quality homes. Although the prices have been depressed, the repair and maintenance costs of these homes have not. The MAI calculation using a computer system as well as networks such as the internet can be used to compare and calculate the MAI on mass to determine if a loan or loans meet acceptable risk tolerance for the user. This will alert lenders when to require that the condition of such homes be certified and/or home warranties be included. This will also allow for them to plan for the impact these homes will have on portfolios, such as excessive foreclosure costs to restore maintain and rehab these homes in foreclosure, and early pay off of the loan to realize quick profits. The result will be Servicers and/or traders should remove these homes from their portfolios, selling them more quickly than homes that do not meet these conditions. In addition these loans can be avoided or made with more cautions terms with this simple MAI calculation, resulting in a great deal of savings to mortgage lenders and servicers.

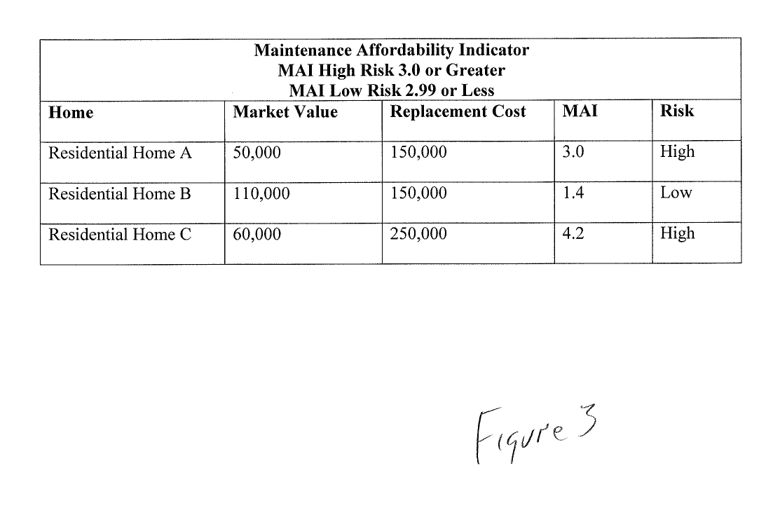

An example use of the method of the present invention is shown in FIG. 3. Of course, the risk levels would be adjusted to lenders requirements and are shown here only for demonstrative purposes. In this example, the Maintenance Affordability Indicator is defined as a ratio of replacement cost to market value, although other mathematical comparisons could be used such as difference in dollars, % difference, etc. The MAI threshold in this example is defined such that the threshold for a High Risk is 3.0 or Greater. A MAI of 2.99 or less is considered Low Risk. Of course, more than two levels could also be defined (such as high, moderate, low, or high, moderate high, moderate low, low, etc).

As shown, for Residential Home A with a market value of $50,000 and a Replacement Cost of $150,000, the MAI is calculated as 3.0. Since that MAI exceeds 3.0, the loan or mortgage for Residential Home A is considered High Risk because there is an increased likelihood that the owner will not adequately maintain the home.

For Residential Home B with a market value of $110,000 and a Replacement Cost of $150,000, the MAI is calculated as 1.4. Since that MAI is below 3.0, the loan or mortgage for Residential Home B is considered Low Risk because it is expected that the owner will adequately maintain the home.

For Residential Home C with a market value of $60,000 and a Replacement Cost of $250,000, the MAI is calculated as 4.2. Since that MAI is above 3.0, the loan or mortgage for Residential Home C is considered High Risk because there is an increased likelihood that the owner will not adequately maintain the home.

Again, this information can be used to evaluate a portfolio of loans or mortgages, such the user may choose to purchase or not to purchase the portfolio (or may choose to sell or keep the portfolio) based upon the MAIs for the loans or mortgages in the portfolio. Alternatively, the user can choose to sell the loans or mortgages indicated as higher risk. Of course, the MAI is only one component of risk that could be combined with standard or known risk factors in evaluating the loan or loans (such as information about the borrowers, like income, credit score, etc and other information regarding the property, such as market value

Although a preferred embodiment has been disclosed, a worker of ordinary skill in this art would recognize that certain modifications would come within the scope of this invention. For that reason, the following claims should be studied to determine the true scope and content of this invention.

What is claimed is:

1. A method of assessing risk for a loan secured by real property including the steps of:
a) receiving a market value of the property in at least one computer;
b) receiving a replacement cost for the property in the at least one computer;
c) comparing the market value to the replacement cost with the at least one computer;
d) determining a maintenance affordability indicator (MAI) for the property based on said step c) with the at least one computer; and
e) the at least one computer assigning a level of risk based upon the MAI.

2. The method of claim 1 wherein said step e) further includes steps of comparing the MAI to at least one threshold.

3. The method of claim 1 wherein said step e) further includes the step of determining a high level of risk if the replacement cost exceeds the market value by more than a threshold.

4. The method of claim 1 wherein said steps a-e are performed iteratively and automatically by the at least one computer on a plurality of loans.

5. The method of claim 1 wherein a purchase price is used as the market value.

6. The method of claim 1 wherein the loan is for the real property and a structure thereon.

7. The method of claim 6 wherein the structure is a house.

8. The method of claim 7 wherein the loan is a mortgage loan.

9. The method of claim 8 wherein said steps a-e are performed iteratively and automatically by the at least one computer on a plurality of mortgage loans.

10. A computer system for assessing risk for a loan secured by real property comprising:
at least one computer programmed to receive a market value of the property;
the at least one computer programmed to receive a replacement cost for the property;
the at least one computer programmed to compare the market value to the replacement cost and to determine a maintenance affordability indicator (MAI) for the property based on the comparison; and
the at least one computer programmed to assign a level of risk based upon the MAI.

11. The computer system of claim 10 wherein the at least one computer is further programmed to compare the MAI to at least one threshold.

12. The computer system of claim 10 wherein the at least one computer is further programmed to determine a high level of risk if the replacement cost exceeds the market value by more than a threshold.

13. The computer system of claim 10 wherein the at least one computer is further programmed to calculate the MAI and assign levels of risk iteratively and automatically on a plurality of loans.

14. The computer system of claim 10 wherein a purchase price is used as the market value.

15. The computer system of claim 10 wherein the loan is for the real property and a structure thereon.

16. The computer system of claim 15 wherein the structure is a house.

17. The computer system of claim 16 wherein the loan is a mortgage loan.

18. The computer system of claim 17 wherein the at least one computer is further programmed to calculate the MAI and assign levels of risk iteratively and automatically on a plurality of mortgage loans.
